(19) United States
(12) Patent Application Publication
(10) Pub. No.: US 2024/0389595 A1
(43) Pub. Date: Nov. 28, 2024

(54) A PROCESS OF PREPARING AN AGROCHEMICAL OIL DISPERSION AND PRODUCT THEREOF

(71) Applicant: UPL LIMITED, Mumbai (IN)

(72) Inventors: Rajan Ramakant SHIRSAT, Mumbai (IN); Shiv Kumar SHARMA, Mumbai (IN); Pradeep Shamrao SAPKALE, Mumbai (IN)

(21) Appl. No.: 18/694,455

(22) PCT Filed: Sep. 28, 2022
(86) PCT No.: PCT/IB2022/059211

§ 371 Date: Mar. 22, 2024

(30) Foreign Application Priority Data
Sep. 28, 2021 (IN) 202121044003

(51) Int. Cl. A01N 47/38; A01N 25/04; A01N 43/653; A01N 43/76; A01P 13/00

(52) U.S. Cl. CPC A01N 47/38; A01N 25/04; A01N 43/653; A01N 43/76; A01P 13/00

(57) ABSTRACT

The present invention discloses a process for the preparation of stable agrochemical oil dispersion comprising: at least one active ingredient dispersed in an oil phase; and a colloid mixture of viscosity 3500-5000 cps, wherein said process comprising steps of: (1) preparing a dispersion by mixing at least one active ingredient in an oil phase; (2) separately, preparing a colloid mixture of viscosity 3500-5000 cps by mixing rheological additive in an oil phase; (3) adding colloid mixture of step (2) in the dispersion of step (1) to obtain agrochemical oil dispersion.

### TECHNICAL FIELD

The present invention relates to a process of preparing an agrochemical oil dispersion. The present invention more particularly relates to a process of preparing an agrochemical oil dispersion and a product thereof. The process involves preparation of a colloid mixture of specific viscosity range that provides desired rheological support to the agrochemical oil dispersion. The presence of colloid mixture imparts long term stability to an agrochemical oil dispersion obtained according to the process of the present invention.

### BACKGROUND OF THE INVENTION

Agrochemical oil dispersions (OD) are stable suspensions of agrochemical active ingredients, such as pesticides and crop protection chemicals, in non-aqueous media, which may contain other dissolved active ingredients and are usually intended for dilution with water before use.

OD formulations are fast becoming indispensable in the agrochemical industry as a way of formulating hydrolytically unstable actives. They are, however, notoriously difficult to structure effectively due to the high density of the active ingredients. This often leads to an unacceptably high viscosity formulation which still sediments to some degree. Typical non-aqueous media used in formulating OD include aromatic and non-aromatic hydrocarbons, halogenated aromatic and non-aromatic hydrocarbons, aromatic and non-aromatic ethers, esters or amides and oils, including, but not limited to, vegetable oils and paraffin oils. Oil dispersions are particularly useful for formulating oil insoluble solid active ingredients.

A common problem exist with most of the oil dispersion compositions is its stability upon storage. The oil dispersion often shows phase separation after it is stored. Thus, storage even at ambient temperature frequently leads to aggregation effects, syneresis, lump formation or pronounced settling of the suspended phase. In the worst cases, the effects are irreversible, i.e. even shearing, for example by stirring, cannot re-homogenize the formulation.

A common method to solve this problem is to add to the dispersions, as anti-settling agent, a rheological additive that increases the viscosity of the system and acts as suspending agent by reducing the settling rate of the particles.

U.S. Pat. No. 8,298,990 B2 discloses an agrochemical oil dispersion stabilized to particle sedimentation by use of a combination of a clay or silica type rheology modifier and a polymer or oligomer capable of hydrogen bonding i.e. polyethylene glycol or polypropylene glycol.

U.S. Pat. No. 9,012,515 discloses oil formulations with rheological additives wherein rheological additive enables significant higher weight ratio of solid particles in the composition. The rheological additives selected from cellulose-based rheological additives, for example hydroxyethyl cellulose, methylcellulose, hydroxypropyl cellulose and carboxymethyl cellulose; polymeric rheological additives formed from at least one of acrylates, alkylacrylates, and anhydrides; and organoclays. The process of preparing such oil formulations suggest mixing of active ingredient, oil medium and rheological additive and further milling it to obtain the final composition.

WO2012080208A1 discloses a method for the preparation of an agrochemical oil dispersion by mixing solid agrochemical active ingredient and oil; and adding an amide rheological additive.

WO2009004281 discloses bentone clays suitable for use with low polarity organic systems that can be activated by certain emulsifiers instead of polar species. It discloses a method of activating an organoclay stabiliser, which organoclay stabiliser is suitable for use with a low polarity liquid, comprising mixing the organoclay stabiliser with an emulsifier selected from the group consisting of alkyl ethoxylates, alkyl ethoxylate phosphate esters, alkyl sulphates, alkyl ammonium salts and castor oil ethoxylates, under high shear conditions in the presence of a low polarity liquid.

EP0789999A2 discloses an oil suspension concentrate comprising at least one active ingredient, at least one surfactant selected from the group of alkyl ethoxylates and alkylaryl ethoxylates and one surfactant selected from the group of alkyl sulfonates and alkyl aryl sulfonates and a hydrophobized aluminium layer silicate from the bentonite series as a rheological additive.

Therefore, attempts have already been made to incorporate rheological additives in various ways to the oil dispersion, such as activating rheological additives in the presence of a chemical activator in order to function as anti-settling agents with good gel strength; or activating it prior to its incorporation in the dispersion. There is still a need exist to improve the physical stability of oil dispersions and oil suspension concentrates of a variety of agrochemical active ingredients using innovative as well as improved processes that solve the problem of phase separation, settling and unacceptable thickening of the oil dispersion formulation.

### Objectives of the Invention

An object of the present invention is to provide a process of preparing stable agrochemical oil dispersion.

Another object of the present invention is to provide a process of preparing stable agrochemical oil dispersion that involves preparing colloid mixture of controlled viscosity.

Another object of the present invention is to provide stable agrochemical oil dispersion.

Another object of the present invention is to provide stable agrochemical oil dispersion with controlled viscosity.

Another object of the present invention is to provide stable agrochemical oil dispersion of triazolinone herbicide with controlled viscosity.

Yet another object of the present invention is to provide a method of controlling weeds using stable agrochemical oil dispersion of triazolinone herbicide.

Another object of the present invention is to provide use of the stable agrochemical oil dispersion of triazolinone herbicide.

### SUMMARY OF THE INVENTION

According to an aspect of the present invention, a process for the preparation of stable agrochemical oil dispersion comprising: at least one active ingredient dispersed in an oil phase; and a colloid mixture of viscosity 3500-5000 cps, wherein said process comprising steps of:
(1) preparing a dispersion by mixing at least one active ingredient in an oil phase;
(2) separately, preparing a colloid mixture of viscosity 3500-5000 cps by mixing rheological additive in an oil phase;
(3) adding colloid mixture of step (2) in the dispersion of step (1) to obtain agrochemical oil dispersion.

According to an aspect of the present invention, a process for the preparation of stable agrochemical oil dispersion comprising: at least one active ingredient dispersed in an oil phase; and a colloid mixture of viscosity 3500-5000 cps, wherein said process comprising steps of:
(1) preparing a dispersion by mixing at least one active ingredient in an oil phase wherein said active ingredient is selected from the group comprising of triazinone, triazole, triazolecarboxamide, triazolinone, triazolinone, N-phenyltriazolinone and N-phenyltriazolinone herbicides;
(2) separately, preparing a colloid mixture of viscosity 3500-5000 cps by mixing rheological additive in an oil phase;
(3) adding colloid mixture of step (2) in the dispersion of step (1) to obtain agrochemical oil dispersion.

According to an aspect of the present invention, a process for the preparation of stable agrochemical oil dispersion comprising: at least one active ingredient dispersed in an oil phase; and a colloid mixture of viscosity 3500-5000 cps, wherein said process comprising steps of:
(1) preparing a dispersion by mixing at least one active ingredient in oil phase wherein active ingredient is selected from triazolinone herbicide;
(2) milling the dispersion of step (1) to achieve desired particle size;
(3) separately, preparing colloid mixture of viscosity 3500-5000 cps by mixing rheological additive in an oil phase;
(4) adding colloid mixture of step (3) to the dispersion of step (1) to obtain agrochemical oil dispersion.

According to an aspect of the present invention, the stable agrochemical oil dispersion comprising:
at least one active ingredient dispersed in an oil phase; and
a colloid mixture of viscosity 3500-5000 cps.

According to another aspect of the present invention, the stable agrochemical oil dispersion comprising:
at least one active ingredient dispersed in an oil phase; and 5-15% colloid mixture of viscosity 3500-5000 cps

According to an aspect of the present invention, a method of controlling weeds wherein said method comprising applying onto weeds or to their locus, an agrochemical oil dispersion comprising:
at least one active ingredient dispersed in oil phase; and
a colloid mixture of viscosity 3500-5000 cps.

According to another aspect of the present invention, an agrochemical oil dispersion is used as herbicide.

### DETAILED DESCRIPTION OF THE INVENTION

The particulars shown herein are by way of example and for purposes of illustrative discussion of the various embodiments of the present invention only and are presented in the cause of providing what is believed to be the most useful and readily understood description of the principles and conceptual aspects of the invention. In this regard, no attempt is made to show details of the invention in more detail than is necessary for a fundamental understanding of the invention, the description making apparent to those skilled in the art how the several forms of the invention may be embodied in practice.

The present invention will now be described by reference to more detailed embodiments. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise. All publications, patent applications, patents, and other references mentioned herein are expressly incorporated by reference in their entirety.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

Inventors of the present invention observed that, the incorporation of rheological additives in the oil dispersion shows marked increase in viscosity which subsequently comes down upon standing. Such variability in viscosity creates problem in achieving desired physico-chemical profile of an oil dispersion. Surprisingly, inventors found that a stable agrochemical oil dispersion composition can be obtained by a peculiar process that involves separately preparing a colloid mixture of viscosity 3500-5000 cps and incorporating it in the separately prepared mill base of the active ingredient(s) along with other excipients. The rheological additive is first mixed in non-aqueous solvent separately and processed to obtain colloid mixture of viscosity ranging from 3500-5000. Such colloid mixture is added to the oil phase in which agrochemicals active ingredient(s) and other suitable dispersing agents are dissolved to obtain said agrochemical oil dispersion. Inventors found that the incorporation of a colloid mixture of viscosity 3500-5000 cps prepared by separately mixing rheological additive in non-aqueous solvent result into stable oil dispersion with uniform viscosity as well as stable physico-chemical profile.

Inventors of the present invention observed that stage of addition of colloid mixture while developing an oil dispersion plays a critical role in terms of stability of the invention. When a colloid mixture is added along with active ingredient and other suitable dispersants in the solvent and homogenized to obtain oil dispersion; it has been observed that over the period of time such oil dispersion thickens due to increase in viscosity and it becomes difficult to pour such oil dispersion from the storage vessel rendering it useless.

When active ingredient as well as suitable dispersants are added in the solvent and milled through suitable means to obtain homogenized mill base; and pre-formulated colloid mixture is added to the mill base, results into a stable oil dispersion. Such oil dispersion exhibits long term storage stability with little or no alteration in viscosity.

As used herein, the term colloid mixture refers to a refers to a blend capable of providing structuring to the oil dispersion composition.

As used herein, the term rheological additive refers to compounds that provide requisite thickening to the oil dispersion composition.

In the present disclosure, an oil phase or a non-aqueous solvent are used interchangeably and corresponds to the continuous phase of an oil dispersion composition.

According to an embodiment of the present invention, a process for the preparation of the stable agrochemical oil dispersion comprising steps of:
(1) preparing a dispersion by mixing at least one active ingredient in an oil phase;
(2) separately, preparing a colloid mixture of viscosity 3500-5000 cps by mixing rheological additive in an oil phase;
(3) adding colloid mixture of step (2) in the dispersion of step (1) to obtain agrochemical oil dispersion.

According to an embodiment of the present invention, active ingredient used for preparing agrochemical oil dispersion is selected from herbicides, fungicides and insecticides.

According to an embodiment of the present invention, active ingredient used for preparing agrochemical oil dispersion is selected from herbicides.

According to an embodiment of the present invention, active ingredient used for preparing agrochemical oil dispersion is selected from triazinone, triazole, triazolecarboxamide, triazolone, triazolinone and N-phenyltriazolinone herbicides, their salts and derivatives thereof.

According to an embodiment of the present invention, active ingredient used for preparing agrochemical oil dispersion is a solid-state herbicide.

According to an embodiment of the present invention, active ingredient used for preparing agrochemical oil dispersion is a triazolinone herbicide.

According to an embodiment of the present invention, active ingredient used for preparing agrochemical oil dispersion is a flucarbazone-sodium.

According to an aspect of the present invention, a process for the preparation of stable agrochemical oil dispersion comprising: at least one active ingredient dispersed in an oil phase; and a colloid mixture of viscosity 3500-5000 cps, wherein said process comprising steps of:
(1) preparing a dispersion by mixing at least one active ingredient in an oil phase wherein said active ingredient is selected from the group comprising of triazinone, triazole, triazolecarboxamide, triazolinone, triazolinone, N-phenyltriazolinone and N-phenyltriazolinone herbicides;
(2) separately, preparing a colloid mixture of viscosity 3500-5000 cps by mixing rheological additive in an oil phase;
(3) adding colloid mixture of step (2) in the dispersion of step (1) to obtain agrochemical oil dispersion.

According to an embodiment of the present invention, the process for the preparation of stable agrochemical oil dispersion comprising steps of:
(1) preparing a dispersion by mixing at least one active ingredient in oil phase wherein active ingredient is selected from triazolinone herbicide;
(2) milling the dispersion of step (1) to achieve desired particle size;
(3) separately, preparing colloid mixture of viscosity 3500-5000 cps by mixing rheological additive in an oil phase; and
(4) adding colloid mixture of step (3) to the dispersion of step (1) to obtain agrochemical oil dispersion.

According to an embodiment, the process for the preparation of the stable agrochemical oil dispersion comprising steps of:
(1). preparing a dispersion by mixing at least one active ingredient in oil phase wherein active ingredient is selected from triazolinone herbicide and optionally safener, dispersing agents and other auxiliary agents;
(2). milling the dispersion of step (1) to achieve desired particle size of the suspended particles;
(3). separately, mixing rheological additive in a portion of oil phase to obtain colloid mixture;
(4). adding colloid mixture of step (3) to dispersion of step (2) under stirring to obtain stable agrochemical oil dispersion.

According to an embodiment of the present invention, dispersing agrochemical active ingredient in an oil phase in the presence of dispersants to obtain dispersed mixture is carried out in homogenizer or medium/high velocity disperser or similar equipment.

According to an embodiment of the present invention, oil phase corresponds to the continuous phase of an oil dispersion composition.

According to an embodiment, safener is first melted in hot water bath prior to its mixing with an oil phase.

According to an embodiment of the present invention, the process of preparing stable agrochemical oil dispersion involves milling the dispersed mixture to achieve desired particle size D50 from about 3 micron to about 12 micron of the suspended particles.

According to an embodiment of the present invention, the process of preparing stable agrochemical oil dispersion involves milling the dispersed mixture to achieve desired particle size D90 from about 6 micron to about 25 micron of the suspended particles.

According to an embodiment of the present invention, milling process must be carried out in a mill suitable for solids and liquids, with glass or zirconium balls.

According to an embodiment of the present invention, colloid mixture is obtained by mixing rheological additive in a portion of oil phase under high shear for about 5 minutes to 30 minutes.

According to an embodiment of the present invention, colloid mixture is obtained by mixing rheological additive in a portion of oil phase under high shear for about 10 minutes.

According to an embodiment of the present invention, colloid mixture is obtained by mixing rheological additive in a portion of oil phase under high shear for about 20 minutes.

According to an embodiment of the present invention, colloid mixture is obtained by mixing rheological additive in a portion of oil phase under high shear for about 25 minutes. According to an embodiment of the present invention, colloid mixture is kept aside for 5-7 hours before its incorporation to the dispersion of active ingredient.

According to an embodiment of the present invention, colloid mixture is kept aside for 5.5 hours before its incorporation to the dispersion of active ingredient.

According to an embodiment of the present invention, colloid mixture is kept aside for 6 hours before its incorporation to the dispersion of active ingredient.

According to an embodiment of the present invention, colloid mixture is kept aside for 6.5 hours before its incorporation to the dispersion of active ingredient.

According to an embodiment of the present invention, colloid mixture is obtained by mixing rheological additive selected from clay, fumed silica, precipitated silica, bentonite or a combination thereof; in a portion of oil phase under high shear.

According to an embodiment of the present invention, colloid mixture is obtained by mixing bentonite in a portion of oil phase under high shear.

According to an embodiment of the present invention, colloid mixture is obtained by mixing fumed silica in a portion of oil phase under high shear.

According to an embodiment of the present invention a process for the preparation of an agrochemical oil dispersion comprises dispersing at least one solid agrochemical active ingredient wherein solid agrochemical active ingredient is selected from triazolinone herbicide in oil phase in the presence of dispersants to obtain dispersed mixture.

According to an embodiment of the present invention, the solid agrochemical active ingredient is selected from triazolinone herbicide.

According to an embodiment of the present invention, the triazolinone herbicide is selected from the group comprising of flucarbazone, sulfentrazone, carfentrazone, thiencarbazone, bencarbazone and amicarbazone, their salts and derivatives thereof.

According to an embodiment of the present invention, triazolinone herbicide is flucarbazone.

According to an embodiment of the present invention, the triazolinone herbicide is flucarbazone-sodium.

According to an embodiment, the process for the preparation of the stable agrochemical oil dispersion comprising: flucarbazone sodium and a safener, cloquintocet-mexyl in an oil phase; and a colloid mixture of viscosity 3500-5000 cps, wherein said process comprising steps of:
(1). preparing a dispersion by mixing flucarbazone sodium, cloquintocet-mexyl, dispersing agents and other auxiliary agents;
(2). milling the dispersion of step (1) to achieve desired particle size of the suspended particles;
(3). separately, mixing bentonite in a portion of oil phase to obtain colloid mixture;
(4). adding colloid mixture of step (3) to dispersion of step (2) under stirring to obtain stable agrochemical oil dispersion.

According to an embodiment, the process for the preparation of the stable agrochemical oil dispersion comprising: flucarbazone sodium and a safener, cloquintocet-mexyl in an oil phase; and a colloid mixture of viscosity 4000-4500 cps, wherein said process comprising steps of:
(1). preparing a dispersion by mixing flucarbazone sodium, cloquintocet-mexyl, dispersing agents and other auxiliary agents;
(2). milling the dispersion of step (1) to achieve desired particle size of the suspended particles;
(3). separately, mixing bentonite in a portion of oil phase and keeping aside for 4-5 hours to obtain colloid mixture;
(4). adding colloid mixture of step (3) to the dispersion of step (2) under stirring to obtain stable agrochemical oil dispersion.

According to an embodiment of the present invention, the stable agrochemical oil dispersion comprising:
at least one active ingredient dispersed in oil phase; and
a colloidal mixture of viscosity 3000-5000 cps.

The stable agrochemical oil dispersion developed according to the invention exhibits controlled viscosity ranging from 100 cps to 2000 cps.

The stable agrochemical oil dispersion developed according to the invention exhibits controlled viscosity ranging from 300 cps to 2000 cps.

The stable agrochemical oil dispersion developed according to the invention exhibits controlled viscosity which is lesser than 1500 cps.

The stable agrochemical oil dispersion developed according to the invention exhibits controlled viscosity which is lesser than 1000 cps.

The stable agrochemical oil dispersion developed according to the invention exhibits controlled viscosity which is lesser than 700 cps.

The stable agrochemical oil dispersion developed according to the invention exhibits controlled viscosity which is lesser than 500 cps.

The stable agrochemical oil dispersion developed according to the invention exhibits controlled viscosity ranging from 100-800 cps.

The stable agrochemical oil dispersion developed according to the invention remains pourable from the storage vessel.

According to an embodiment of the present invention, the stable agrochemical oil dispersion comprises at least one active ingredient selected from herbicide, fungicide or insecticide classes.

According to an embodiment of the present invention, the active ingredient is an herbicide.

According to an embodiment of the present invention, an herbicide is selected from the group comprising of phenoxy acid derivatives, bipyridyl derivatives, ureas and thioureas (phenyl or substituted ureas), organic phosphorus/phosphonomethyl amino acids or inhibitors of aromatic acid biosynthesis, protoporphyrinogen oxidase inhibitors (PROTOX) DPE or non-DPE, triazines, triazolinones, triazolinones and triazoles, substituted anilines, amides and acetamides, dinitro compounds, triazolopyrimidines, imidazolinones, benzoic acids, carbamate and thiocarbamate compounds, methyl uracil compounds, polycyclic alkanoic acids, dinitroaniline and nitriles.

According to an embodiment of the present invention, the active ingredient of triazolinone herbicide class is selected from the group comprising of flucarbazone, flucarbazone sodium and sulfentrazone.

According to an embodiment of the present invention, the active ingredient of triazolone herbicide is amicarbazone.

According to an embodiment of the present invention, the active ingredient comprises from about 1% w/w to about 70% w/w, preferably 5% w/w to about 50% w/w herbicide of the total weight of the stable agrochemical oil dispersion.

According to an embodiment, the stable agrochemical oil dispersion comprises of an oil phase.

According to an embodiment, oil phase forms the continuous phase of the oil dispersion.

According to an embodiment, oil comprising the oil phase is selected from the group comprising of alkyl esters, soybean oil, rapeseed oil, olive oil, castor oil, sunflower seed oil, coconut oil, corn oil, cottonseed oil, linseed oil, palm oil, peanut oil, safflower oil, sesame oil, tung oil kapok oil, papaya oil, camellia oil, rice bran oil, esters of any of the foregoing, alkoxylated oils of any of the foregoing, methyl and ethyl esters of fatty acids, mineral oils, paraffinic and isoparaffinic oils, esters, aromatic solvents, and combinations of one or more of the foregoing; the stable agrochemical oil dispersion described above where the oil of an oil phase is selected from the group comprising of methylated rapeseed oil, ethoxylated soybean oil, methyl-5-(dimethylamino)-2-methyl-5-oxopentanoate, alkyl dimethylamide, 2-ethylhexyl lactate, methyl caprylate caproate, methyl stearate, canola oil, and combinations of one or more of the foregoing.

According to an embodiment, oil phase comprises of solvents conventionally used to form continuous phase of an oil dispersion.

According to an embodiment, oil comprising the oil phase is selected from the group comprising of solvent selected from the group consisting of octane, decane, dodecane, tetradecane, xylene, toluene, naphthalene, hexane, cyclohexane, benzene or its derivatives, petroleum solvents, paraffinic liquids, white mineral oil, silicone oils, and organic epoxides, and mixtures thereof.

According to an embodiment, oil phase comprises of an ester of aromatic carboxylic acid.

According to an embodiment, oil phase comprises of C1-C4 alkyl ester of aromatic carboxylic acid.

According to an embodiment, the stable agrochemical oil dispersion comprises of an oil phase selected from C1-4 alkyl ester of benzoic acid, preferably butyl ester (butyl benzoate).

According to an embodiment, the stable agrochemical oil dispersion comprises from about 10% w/w to about 90% w/w, preferably 20% w/w to about 80% w/w oil phase of the total weight of the stable agrochemical oil dispersion.

According to an embodiment, the stable agrochemical oil dispersion comprises of a colloid mixture.

According to an embodiment, the colloid mixture is comprised of a rheological additive and an oil phase.

According to an embodiment, the rheological additive is selected from the group comprising of polyacrylics, polyacrylamides, hydrophobically modified cellulose derivatives, modified starches, co-polymers of cellulose derivatives, carboxyvinyl or polyvinyl pyrrolidones, polyethylenes, polyvinyl alcohol and derivatives, clays, attapulgites, magnesium stearate, or aluminium/magnesium hydroxide stearate, silicas such as hydrophobic fumed silica, precipitated silica, and natural gums such as guar gum, gelatin, dextrin, collagen and derivatives or combination thereof.

According to an embodiment, the rheological additive is selected from the group comprising silica and silicone derivatives such as precipitated silica and fumed silica.

According to an embodiment, the rheological additive is selected from the group comprising natural clays and modified clays.

According to an embodiment, the natural clays and modified clays are selected from the group comprising of organically modified bentonite, hectorite and smectite clays, for example tetra alkyl ammonium bentonite (for example Bentone™ 34), tetra alkyl ammonium hectorite (for example Bentone™ 38), tetra(alkyl/aryl) ammonium bentonite (for example Bentone SD™-1, Bentone™ 52, Bentone™ 120, and Bentone™ 1000), alkylaryl ammonium hectorite (for example Bentone SD™-3).

According to an embodiment, the rheological additive is tetra(alkyl/aryl) ammonium bentonite.

According to an embodiment, the stable agrochemical oil dispersion comprises from about 0.1% w/w to about 20% w/w, preferably 0.5% w/w to about 15% w/w rheological additive of the total weight of the stable agrochemical oil dispersion.

According to an embodiment, the stable agrochemical oil dispersion comprises of a colloid mixture of viscosity less than or equal to 5000 cps.

According to an embodiment, the stable agrochemical oil dispersion comprises of a colloid mixture of viscosity less than 4500 cps.

According to an embodiment, the stable agrochemical oil dispersion comprises of a colloid mixture of viscosity less than 4000 cps.

According to an embodiment, the stable agrochemical oil dispersion comprises of a colloid mixture of viscosity ranging from 3500-3800 cps.

According to another aspect of the present invention, the agrochemical oil dispersion comprising:

at least one active ingredient dispersed in oil phase; and 5-15% colloid mixture of viscosity 3500-5000 cps

According to an embodiment of the present invention, the colloid mixture is obtained by mixing rheological additive selected from clay, fumed silica, precipitated silica, bentonite and combinations thereof; in an oil phase.

According to an embodiment, the colloid mixture is obtained by mixing rheological additive in oil phase in a ratio from 1:5 to 1:15.

According to an embodiment, the colloid mixture is obtained by mixing rheological additive in oil phase in 1:8 ratio.

According to an embodiment, the colloid mixture is obtained by mixing rheological additive in oil phase in 1:10 ratio.

According to an embodiment, the colloid mixture is obtained by mixing rheological additive in oil phase in 1:12 ratio.

According to an embodiment, the stable agrochemical oil dispersion comprises from about 5% w/w to about 15% w/w, preferably 6% w/w to about 12% w/w colloid mixture of the total weight of the stable agrochemical oil dispersion.

According to an embodiment, the stable agrochemical oil dispersion comprises of dispersing agents.

According to an embodiment, the stable agrochemical oil dispersion comprises of anionic and non-ionic dispersing agents.

According to an embodiment, the non-ionic dispersing agents are selected from the group comprising of fatty alcohol ethoxylates, tristyrylphenol ethoxylates, alkylphenolethoxylates, castor oil ethoxylates, fatty acid ethoxylates, alkylpolyglucosides, sorbitan ethoxylates, and ethylene oxide-propylene oxide-ethylene oxide block copolymers.

According to an embodiment, the anionic dispersing agents are selected from the group comprising salts of dodecylbenzenesulfonate, sodium dioctylsulfosuccinate, salts of tristyrylphenol ethoxylate phosphates, salts of fatty acids, salts of alkyl sulfates, salts of alkylether sulfates, salts of alkylether phosphates, and sodium N-methyl-N-oleyltaurate.

According to an embodiment, the stable agrochemical oil dispersion comprises from about 1% w/w to about 25% w/w, preferably 5% w/w to about 20% w/w dispersing agents of the total weight of the stable agrochemical oil dispersion.

According to an embodiment, the stable agrochemical oil dispersion comprises of safeners.

According to an embodiment, the safeners are selected from the group comprising of benoxacor, cloquintocet, cloquintocet mexyl, cumyluron, cyometrinil, cyprosulfamide, daimuron, dichlormid, dicyclonon, dimepiperate, fenchlorazole-ethyl, fenclorim, flurazole, fluxofenim, furilazole, isoxadifen-ethyl, mefenpyrdiethyl, mephenate, methoxyphenone, naphthalic anhydride, oxabetrinil, N-(aminocarbonyl)-2-methylbenzenesulfonamide and N-(aminocarbonyl)-2-fluorobenzenesulfonamide, I-bromo-4[(chloromethyl)sulfonyl]benzene, 2-(dichloromethyl)-2-methyl-1,3-dioxolane (MG 191), 4 (dichloroacetyl)-I-oxa-4-azospiro [4.5]decane (MON 4660).

According to an embodiment, the safener is cloquintocet-mexyl.

According to an embodiment, the stable agrochemical oil dispersion comprises from about 0.1% w/w to about 20% w/w, preferably 0.5% w/w to about 10% w/w safener of the total weight of the stable agrochemical oil dispersion.

According to an embodiment of the present invention, the stable agrochemical oil dispersion may include one or more adjuvants selected from wetting agent, fertilizers, surfactants, compatibility agents, stabilizers, defoamers, antimicrobial agents, antioxidants, correctives, absorbent, an antifreeze agent, a base, an acid, a buffer and spray colorants (dyes).

According to an embodiment of the present invention, the stable agrochemical oil dispersion comprises of wetting agent selected the group comprising of soaps; salts of aliphatic monoesters of sulphuric acid including but not limited to, sodium lauryl sulphate; sulfoalkylamides and salts thereof including but not limited to N-methyl-N-oleoyltaurate Na salt; alkylarylsulfonates including but not limited to alkylbenzenesulfonates; alkylnaphthalenesulfonates and salts thereof and salts of ligninsulfonic acid.

According to an embodiment of the present invention, the stable agrochemical oil dispersion comprises of defoamer selected from the group comprising of silicone-based compounds, alcohols, glycol ethers, mineral spirits, acetylene diols, polysiloxanes, organosiloxanes, siloxane glycols, reaction products of silicon dioxide and organosiloxane polymer, polydimethylsiloxanes or polyalkylene glycols alone or in combination. Defoamers that are suitable includes Silcolapse-O and SAG-1572.

According to an embodiment, the stable agrochemical oil dispersion may further comprise of second active ingredient.

According to an embodiment, the second active ingredient is an herbicide.

According to an embodiment of the present invention, the second active ingredient is selected from the group comprising of triazinone, triazole, triazolecarboxamide, triazolone, triazolinone, N-phenyltriazolinone and N-phenyltriazolinone herbicides.

According to an embodiment of the present invention, the second active ingredient is selected from the group comprising of hexazinone, metamitron, metribuzin, amicarbazone, flucarbazone, thiencarbazone, carfentrazone, sulfentrazone and their derivatives.

According to an embodiment, second active ingredient in the stable agrochemical oil dispersion is fenoxaprop-P-ethyl.

According to an embodiment, second active ingredient in the stable agrochemical oil dispersion is pyroxsulam.

According to an embodiment, the stable agrochemical oil dispersion comprises from about 1% w/w to about 70% w/w second active ingredient, from 5% w/w to about 15% w/w colloid mixture of the total weight of the stable agrochemical oil dispersion.

According to an embodiment, the stable agrochemical oil dispersion comprises from about 1% w/w to about 70% w/w second active ingredient, from about 10% w/w to about 90% w/w oil phase, from 5% w/w to about 15% w/w colloid mixture of the total weight of the stable agrochemical oil dispersion.

According to an embodiment, the stable agrochemical oil dispersion comprises from about 1% w/w to about 70% w/w flucarbazone sodium, from about 10% w/w to about 90% w/w butyl benzoate phase, from 5% w/w to about 15% w/w colloid mixture of the total weight of the stable agrochemical oil dispersion.

According to an embodiment, the stable agrochemical oil dispersion comprises from about 1% w/w to about 70% w/w active ingredient and from 5% w/w to about 15% w/w colloid mixture with 3500-5000 cps viscosity of the total weight of the stable agrochemical oil dispersion.

According to an embodiment, the stable agrochemical oil dispersion comprises from about 10% w/w to about 70% w/w active ingredient and from 5% w/w to about 15% w/w colloid mixture with 3800-4500 cps viscosity of the total weight of the stable agrochemical oil dispersion.

According to an embodiment, the stable agrochemical oil dispersion comprises from about 10% w/w to about 70% w/w active ingredient and from 5% w/w to about 15% w/w colloid mixture with 4200-5000 cps viscosity of the total weight of the stable agrochemical oil dispersion.

According to an embodiment, the stable agrochemical oil dispersion comprises from about 1% w/w to about 70% w/w active ingredient, from 5% w/w to about 15% w/w colloid mixture of the total weight of the stable agrochemical oil dispersion, wherein said colloid mixture comprises from about 0.1% w/w to about 10% w/w rheological aid and from about 1% w/w to about 50% w/w oil phase.

According to an embodiment, the stable agrochemical oil dispersion comprises from about 1% w/w to about 70% w/w flucarbazone sodium, from 5% w/w to about 15% w/w colloid mixture of the total weight of the stable agrochemical oil dispersion, wherein said colloid mixture comprises from about 0.1% w/w to about 10% w/w bentonite and from about 1% w/w to about 50% w/w butyl benzoate.

According to an embodiment, the stable agrochemical oil dispersion comprises from about 1% w/w to about 70% w/w flucarbazone sodium, from about 1% w/w to about 70% w/w fenoxaprop-P-ethyl, from 5% w/w to about 15% w/w colloid mixture of the total weight of the stable agrochemical oil dispersion, wherein said colloid mixture comprises from about 0.1% w/w to about 10% w/w bentonite and from about 1% w/w to about 50% w/w butyl benzoate.

According to an embodiment, the stable agrochemical oil dispersion comprises from about 1% w/w to about 70% w/w flucarbazone sodium, from about 1% w/w to about 70% w/w pyroxsulam, from 5% w/w to about 15% w/w colloid mixture of the total weight of the stable agrochemical oil dispersion, wherein said colloid mixture comprises from about 0.1% w/w to about 10% w/w bentonite and from about 1% w/w to about 50% w/w butyl benzoate.

According to an embodiment, the stable agrochemical oil dispersion comprises from about 10% w/w to about 70% w/w active ingredient, from 5% w/w to about 15% w/w colloid mixture of the total weight of the stable agrochemical oil dispersion, wherein said colloid mixture comprises from about 0.1% w/w to about 10% w/w rheological aid and from about 1% w/w to about 30% w/w oil phase.

According to an embodiment of the present invention, colloid mixture is obtained by mixing rheological additive in a portion of oil phase under high shear for about 5 min to 30 min.

According to an embodiment of the present invention, colloid mixture is kept aside for 5-8 hours before its incorporation to the dispersion of active ingredient.

According to an embodiment of the present invention, colloid mixture is kept aside for 5-7 hours before its incorporation to the dispersion of active ingredient.

According to an embodiment of the present invention, colloid mixture is obtained by mixing rheological additive selected from clay, fumed silica, precipitated silica, bentonite or a combination thereof; in a portion of oil phase under high shear.

According to an embodiment of the present invention, colloid mixture is obtained by mixing bentonite in a portion of oil phase under high shear.

According to an embodiment of the present invention, colloid mixture is obtained by mixing fumed silica in a portion of oil phase under high shear.

According to an embodiment of the present invention, a method of controlling weeds wherein said method comprising applying onto weeds or to their locus, an agrochemical oil dispersion comprising:
at least one active ingredient dispersed in oil phase; and
a colloid mixture of viscosity 3500-5000 cps.

According to an embodiment of the present invention, a method of controlling weeds wherein said method comprising applying onto weeds or to their locus, an agrochemical oil dispersion comprising:
at least one active ingredient and a safener dispersed in an oil phase; and
a colloid mixture of viscosity 3500-5000 cps.

According to an embodiment of the present invention, a method of controlling weeds wherein said method comprising applying onto weeds or to their locus, an agrochemical oil dispersion comprising: triazolinone herbicide; and a colloid mixture of viscosity 3500-5000 cps.

According to an embodiment of the present invention, a method of controlling weeds wherein said method comprising applying onto weeds or to their locus, an agrochemical oil dispersion comprising: flucarbazone-sodium; and a colloid mixture of viscosity 3500-5000 cps.

According to an embodiment of the present invention, a method of controlling weeds wherein said method comprising applying onto weeds or to their locus, an agrochemical oil dispersion comprising: triazolinone herbicide and safener dispersed in an oil phase; and a colloid mixture of viscosity 3500-5000 cps.

According to an embodiment of the present invention, a method of controlling weeds wherein said method comprising applying onto weeds or to their locus, an agrochemical oil dispersion comprising: flucarbazone sodium, cloquintocet-mexyl dispersed in an oil phase; and a colloid mixture comprising of viscosity 3500-5000 cps.

According to an embodiment of the present invention, a method of controlling weeds wherein said method comprising applying onto weeds or to their locus, an agrochemical oil dispersion comprising: flucarbazone sodium, cloquintocet-mexyl dispersed in an oil phase; a second herbicide pyroxsulam; and a colloid mixture comprising of viscosity 3500-5000 cps.

According to an embodiment of the present invention, a method of controlling weeds wherein said method comprising applying onto weeds or to their locus, an agrochemical oil dispersion comprising: flucarbazone sodium, cloquintocet-mexyl dispersed in an oil phase; a second herbicide fenoxaprop-p-methyl; and a colloid mixture comprising of viscosity 3500-5000 cps.

According to an embodiment of the present invention, the agrochemical oil dispersion is diluted with water and then applied to plant foliage and/or soil by methods commonly employed in the art, such as conventional high-volume hydraulic sprays, low-volume sprays, air-blast, and aerial sprays. The diluted composition may be applied to the plant foliage or to the soil or area adjacent to the plant. The dilution and rate of application will depend upon the type of equipment employed, the method and frequency of application desired, the recommended herbicide application rate, as well as the weeds to be controlled.

According to an embodiment of the present invention, an agrochemical oil dispersion is used as herbicide.

According to an embodiment of the present invention, the agrochemical oil dispersion can be mixed with fertilizers or fertilizing materials (e.g. at the dilution step) before its application to weeds/crop plants.

According to an embodiment of the present invention, the agrochemical oil dispersion can be utilized as the sole pesticidal agent or it can be employed in conjunction with other pesticidal agents such as, for example, microbicides, fungicides, other herbicides, insecticides, and acaricides, particularly if these have not already been included in the agrochemical oil dispersion of the invention.

According to an embodiment of the present invention, the agrochemical oil dispersion can be used against various weeds including, but not limited to, the following genera and species: Abutilon theophrasti, Abutilum theophasti, Adonis aestivalis, Adonis spp., Aethusa cynapium, Agrostemma githago, Alopecurus myosuroides, Amaranthus blitoides, Amaranthus retroflexus, Amaranthus spp., Ambrosia, Anagallis arvensis, Anthemis spp., Anthemis arvensis, Aphanes arvensis, Arenaria spp., Artemisia spp., Atriplex patula, Avena sterilis, Bilderdykia convolvulus, Boraginaceae spp., Brassica, Bromus, Bugloss, Buglossoides arvensi, Calystegia sepium, Capsella bursa-pastoris, Centaurea cyanus, Cerastium arvense, Chamomilla recutita, Chenopodium album, Chrysanthemum, Chrysanthemum segetum, Cirsium arvense, Convolvulus spp., Convulvulus arvensis, Coronopus spp., Cytisus scoparius, Datura stramonium, Descurainia, Digitaria sanguinalis, Diplotaxis erucoides, Diplotaxis spp., Echinochloa, Echinochloa crus-galli, Epilobium angustifolium, Eriogonum, Eruca vesicaria, Fagopyrum, Fallopia, Fallopia convolvulus, Fumaria officinalis, Galeopsis tetrahit, Gallium aparine, Gallium spp., Geranium molle, Helianthus annus, Hypecoum procumbens, Kochia spp., Lactuca, Lamium amplexicaule, Lamium purpurem, Linum, Lithospermum arvense, Lolium rigidum, Malva sylvestris, Matricaria, Myosotis palustris, Myosotis arventis, Panicum miliaceum, Papaver rhoeas, Parietaria spp., Persicaria lapathifolia, Persicaria maculosa, Polygonum spp., Polygonum aviculare, Portulaca oleracea, Portulaca olerace, Raphanus raphanistrum, Reseda spp., Ridolphia saegetum, Rumex spp., Rumex acetosa, Rumex crispus, Rumex obtusifolius, Salsola kali, Senecio spp., Senecio vulgaris, Setaria verticillata, Setaria viridis, Silene spp., Sinapsis arvensis, Sisymbrium orientalis, Solanum americanum, Solanum nigrum, Sonchus spp., Sonchus oleraceus, Sorghum halepense, Spergula arvensis, Stellaria media, Thlaspi arvense, Ulex spp., Urdica dioica, Urtica urens, Vaccaria segetum, Veronica spp., Veronica hederifolia, Veronica persica, Viola spp., Viola arvensis, Viola bicolor, Volunteer rape, Volunteer sugar beet, Xanthium spp., Xanthium strumarium, and Xantium spinosum.

According to an embodiment of the present invention, the agrochemical oil dispersion can be used to control weeds (such as any of those mentioned above) in crops plants such as cereals crops (e.g. corn, oats (winter and spring), wheat (winter wheat and summer wheat), triticale, durum wheat, rye, barley (winter barley and spring barley), rice, etc.), maize, soya, potatoes, cotton, rapeseed, linseed, beet, sugar cane and also fruit plants.

According to an embodiment of the present invention, the agrochemical oil dispersion can also be used to control weeds in permanent grasslands and newly sown grass leys.

It will be understood that the specification and examples are illustrative but not limitative of the present invention and that other embodiments within the spirit and scope of the invention will suggest themselves to those skilled in the art. Other embodiments can be practiced that are also within the scope of the present invention. The following examples illustrate the invention, but by no means intend to limit the scope of the invention.

### EXAMPLE 1: PREPARATION OF COLLOID MIXTURE

11.7 g butyl benzoate was charged in a beaker and 1.3 g bentonite was added slowly to the beaker with high shear mixing in high-speed homogenizer (1500-1800 rpm) for around 10-20 minutes and kept aside for 5-8 hours to obtain colloid mixture of 10% strength having viscosity ranging from 3500 to 5000 cps (measured in spindle 64/60 rpm).

| Ingredients | Quantity |
|---|---|
| Bentonite | 1.3 |
| Butyl benzoate | 11.70 |
| Total | 13.00 |

### Stabilizing Time Study

The colloid mixture obtained in above step is kept aside for 5-7 hours to observe change in viscosity. The viscosity of colloid mixture was calculated several times after suitable intervals to observe behaviour of rheological additive in the presence of oil phase. It was observed that with each passing time interval, viscosity gradually came down. Initial viscosity of the colloid mixture was 9500 which came down to 4370 cps in 7.3 hours and further came down to 3950 in 24 hours. Afterwards, the viscosity remained constant and does not change further.

TABLE 1

| | |
|---|---|
| | Viscosity in |
| Time | Centipoise (cps) |

| | | |
|---|---|---|
| 20 | min | 9500 |
| 80 | min | 5200 |
| 140 | min | 4900 |
| 320 | min | 3890 |
| 440 | min | 4370 |
| 12 | hours (min) | 4190 |

| | |
|---|---|
| Kept for 24 | 3950 |
| Hours (Undisturbed) | |

### EXAMPLE 2: PREPARATION OF 20% W/W FLUCARBAZONE SODIUM OIL DISPERSION (OD)

Step 1: Preparation of Mill Base 4.11 g cloquintocet mexyl was melted separately on a hot water bath (water Batch Temp is 95 deg C.) and kept aside. 46.85 g butyl benzoate was charged in a mixing vessel and molten cloquintocet mexyl was added under stirring. 1 g block copolymeric surfactant, 6 g fatty alcohol ethoxylate, 2 g calcium alkylbenzene sulfonate and 7 g fatty acid ethoxylate were added to the same mixing vessel under continuous stirring. 20.04 g flucarbazone sodium was then added and homogenized to obtain homogeneous mixture.

| Ingredients | Quantity |
|---|---|
| Butyl benzoate | 46.85 |
| Cloquintocet mexyl (Molten) | 4.11 |
| Non-ionic surfactant | 14 |
| Anionic surfactants | 2 |
| Flucarbazone sodium | 20.04 |
| Total | 87 |

### Step 2: Preparation of Colloid Mixture

11.7 g butyl benzoate was charged in a beaker and 1.3 g bentonite was added slowly to the beaker with high shear mixing for around 10-20 minutes and kept aside for 8 hours to obtain colloid mixture of 3900 cps (10% gel).

| Ingredients | Quantity |
|---|---|
| Bentonite | 1.3 |
| Butyl benzoate | 11.70 |
| Total | 13.00 |

### Step 3: Preparation of Agrochemical Oil Dispersion

Under continuous stirring, colloid mixture was added to the mill base and homogenized for around 45-50 minutes to obtain stable agrochemical oil dispersion.

| Ingredients | Quantity (w/w) |
|---|---|
| Mill base | 87 |
| Colloid mixture | 13 |
| Total | 100 |

### EXAMPLE 3: PREPARATION OF 20% W/W FLUCARBAZONE SODIUM OIL DISPERSION (OD) (COMPARATIVE EXAMPLE)

An oil dispersion was prepared according to conventional process of preparation that involves mixing all the ingredients together, followed by milling the mixture to obtain desired particle size to obtain oil dispersion. Therefore, flucarbazone sodium herbicide, cloquintocet-mexyl, butyl benzoate, calcium alkylbenzene sulfonate, fatty acid ethoxylate, isotridecyl alcohol polyglycol ether, organoclay and polymeric dispersant were mixed together followed by milling the mixture up to desired particle size to obtain an oil dispersion.

| Ingredients | Quantity (% w/w) |
|---|---|
| Butyl benzoate | 59.94 |
| Flucarbazone sodium | 20.31 |
| Cloquintocet-mexyl | 4.02 |
| Calcium alkylbenzene sulfonate | 7 |
| Fatty acid ethoxylate | 2 |
| Isotridecyl alcohol polyglycol ether | 6 |
| Organoclay | 1.15 |
| Polymer dispersant | 1 |
| Total | 100 |

### Comparative Study of Agrochemical Oil Dispersions

The formulation characteristics such as pourability and viscosity of the agrochemical oil dispersions developed according to Example-2 and Example-3 were compared. Pourability was measured by in house method: The 80 ml OD composition was filled in 100 ml HDPE bottle. First observation was made by tilting the graduated cylinder at 90 degree and pouring the entire content from graduated cylinder onto 100 ml glass beaker. Entire amount of the composition came out from the cylinder. Again, The 80 ml OD composition was filled in 100 ml HDPE bottle and was given 10 inversions. Second observation was made by tilting the graduated cylinder at 90 degree and pouring the entire content from graduated cylinder onto 100 ml glass beaker. Entire amount of the composition came out from the cylinder. It was observed that the composition of Example-2 retained good pourability of close to 100% in ambient as well as in 14 days AHS (Accelerated Heat Stability) study, both at 0 inversion and 10 inversions. Therefore, OD composition of Example-2 found to pass pourability test satisfactorily. Viscosity was measured as per CIPAC MT 192. Viscosity of the composition of Example-2 found to be 492 cps which increased within acceptable limit to 602 in 14 days AHS. Composition of Example-2 was kept under observation to check stability of the OD formulation in real time. The sample was kept for 15 months in ambient conditions. The viscosity of the composition of was found to be 296 cPs in real time. The slight change in viscosity observed was within acceptable range. Upon visual inspection, OD found clear without any thickening or phase separation. OD formulation found to be acceptable after 15 months.

Similarly, composition of Example-3 found to be 100% pourable at ambient condition but it became too thick that viscosity could not be measured when sample was taken out after 14 days AHS. Composition of Example-3 found to have a viscosity of 578 cps in ambient and further in 14 days AHS, sample became too thick that viscosity could not be measured.

TABLE 2

| | 14 days Aging Data of Pourability | | | | |
|---|---|---|---|---|---|
| | Example 2 | | | Example 3 | |
| | 0 days | 14 days | 15 months | 0 days | 14 days |
| | (Ambient) | (AHS) | (RT) | (Ambient) | (AHS) |
| 0 inversion | 100% | 91.32 | 95 | 100% | Not measurable. |
| | pourable | | | pourable | (Thick |
| | | | | | non-pourable |
| | | | | | liquid.) |
| 10 inversion | 100% | 93.56 | 98 | 100% | Not measurable. |
| | pourable | | | pourable | (Thick |
| | | | | | non-pourable |
| | | | | | liquid.) |
| Viscosity (RVT, | 492 | 602 | 296 | 578 | Not measurable. |
| 60 RPM, #3 | | | | | (Thick |
| Spindle (cPs)) | | | | | non-pourable |
| | | | | | liquid.) |
| Remarks | Viscous | Viscous | Viscous | Viscous | Thick |
| | free flowing | free flowing | free flowing | free flowing | non-pourable |
| | liquid | liquid | liquid | liquid | liquid. |

### EXAMPLE 4-8: FEW MORE COMPOSITIONS OF FLUCARBAZONE 20% W/W OD WERE DEVELOPED TO ASCERTAIN EFFECTIVENESS OF COLLOID MIXTURE IN PREPARING AGROCHEMICAL OIL DISPERSIONS

Compositions of Example-4-8 were prepared to confirm the stability of oil dispersion prepared as per the process disclosed in the present invention. Viscosity of colloid mixture prepared as per the process of the present invention by using various rheological additives such as bentonite, modified bentonite, fumed silica and oil phase made of butyl benzoate, mustard oil or soybean oil. The colloid mixture of the compositions of Example 4-8 found to be within desired range of 3500-5000 cPs. Also, viscosity of final OD compositions also found to be stable with viscosity in an acceptable range from 100-650 cPs.

TABLE 3

| | Quantity | | | | |
|---|---|---|---|---|---|
| Ingredients | Example-4 | Example-5 | Example-6 | Example-7 | Example-8 |
| | % w/w | | | | |
| Flucarbazone sodium | 20.04 | 20.04 | 20.04 | 20.04 | 20.04 |
| Cloquintocet mexyl | 4.11 | 4.11 | 4.11 | 4.11 | 4.11 |
| Butyl benzoate | 46.85 | 44.85 | 19 | 46.85 | 46.85 |
| Calcium | 7 | 7 | 4.5 | 7 | 7 |
| alkylbenzene | | | | | |
| sulfonate | | | | | |
| Fatty acid | 2 | 2 | 1.5 | 2 | 2 |
| ethoxylate, | | | | | |
| POE 30 | | | | | |
| Fatty alcohol | 6 | 6 | 4 | 6 | 6 |
| ethoxylate | | | | | |
| Polymeric dispersant | 1 | 1 | 1 | 1 | 1 |
| Methyl ester | 0.00 | 0.00 | 32.05 | 0.00 | 0.00 |
| derived from | | | | | |
| canola oil | | | | | |
| | 87.00 | 85.00 | 86.20 | 87.00 | 87.00 |

Gel Part

| | | | | | |
|---|---|---|---|---|---|
| Bentonite clay | 1.3 | — | — | 1.3 | 1.3 |
| Modified | — | 1.5 | — | — | — |
| bentonite clay | | | | | |
| Hydrophilic | — | — | 0.80 | — | — |
| fumed silica | | | | | |
| Butyl benzoate | 11.7 | 13.5 | 13.00 | — | — |
| Mustard oil | — | — | — | 11.7 | — |
| Soybean oil | — | — | — | — | 11.7 |
| Viscosity@Gel | 3850 | 4950 | 4880 | 3680 | 3712 |
| (3500-5000 cps) | | | | | |
| Viscosity@Oil | 492 | 156 | 290 | 420 | 194 |
| Dispersion (RVT, | | | | | |
| 60 RPM, | | | | | |
| #3 Spindle (cPs)) | | | | | |

### Pourability Study:

The compositions of Example 4-8 prepared as per the process disclosed in the present invention were evaluated for pourability characteristic. It was observed that the compositions of Example 4-8 retained good pourability in ambient conditions, both in 0 inversion and 10 inversions. Viscosity of the composition of Examples 4-8 were also found to be within acceptable range. All the compositions found to be satisfactorily pourable in ambient conditions with more than 85% OD composition coming out from the storage container in 0 inversion and more than 95% OD composition coming out from the storage container in 10 inversions. Compositions of Example 4-6 were kept in AHS and rise in viscosity of the final oil dispersion formulations was calculated. All the three formulations exhibited optimum viscosity with slight deviation within +6%. Compositions of Example-7 and 8 were evaluated in ambient conditions just after (zero day) and found to exhibit viscosity within acceptable limits.

TABLE 4
14 days Aging Data of Pourability

| | | | | | | | Example 7 | Example 8 |
|---|---|---|---|---|---|---|---|---|
| | Example 4 | | Example 5 | | Example 6 | | Ambient (0 | Ambient (0 |
| | Ambient | 7 D AHS | Ambient | 7 D AHS | Ambient | 7 D AHS | days) | days) |
| 0 inversion | 96.89 | 89.21 | 99.45 | 99.23 | 98.58 | 88.27 | 98.3 | 99.31 |
| 10 inversion | 99.89 | 98.89 | 99.87 | 99.67 | 99 | 98.5 | 99.89 | 98.91 |
| RVT, 60 | 492 | 520 | 156 | 146 | 290 | 305 | 420 | 194 |
| RPM, #3 | | | | | | | | |
| Spindle | | | | | | | | |
| (cPs) | | | | | | | | |

| | | | | | |
|---|---|---|---|---|---|
| Remarks | Viscous free | Viscous free | Viscous free | Viscous free | Viscous free |
| | flowing liquid | flowing liquid | flowing liquid | flowing liquid | flowing liquid |

Examples 9-11: The compositions of Example 9 and Example 10 were assessed for pourability and viscosity of the agrochemical oil dispersions developed according to the process described in the present invention. It was observed that the compositions of Example 9 & 10 retained good pourability in ambient conditions, both in 0 inversion and 10 inversions. Viscosity of the composition of Examples 9 & 10 were also found to be within acceptable range. Overall, it was observed that compositions of Example 9 & 10 remained quite pourable with more than 90% contents coming out of the vessel in 0 inversion as well as in 10 inversions. Viscosity of the final oil dispersion formulations also remained controlled without any significant rise and hence resulting into stable OD formulations. (Table 5 and Table 6)

### EXAMPLE 9: AMICARBAZONE 30% OIL DISPERSION (OD)

| Ingredients | Quantity |
|---|---|
| Amicarbazone | 30.00 |
| Butyl benzoate | 40.07 |
| Anionic Surfactant | 8.00 |
| Non-ionic surfactants | 8.93 |

Gel Part

| | |
|---|---|
| Bentonite | 1.3 |
| Butyl benzoate | 11.7 |

Amicarbazone, one part of butyl benzoate, anionic surfactant, non-ionic surfactant and gel part comprising bentonite and remaining part of butyl benzoate were mixed in above quantity and processed as per the Example-1 to obtain oil dispersion composition.

| Ingredients | Quantity (% w/w) |
|---|---|
| Sulfentrazone | 20.00 |
| Butyl benzoate | 50.5 |
| Anionic surfactant | 7.00 |
| Non-ionic surfactants | 9.5 |

Gel Part

| | |
|---|---|
| Bentonite | 1.30 |
| Butyl benzoate | 11.70 |

### EXAMPLE 10: SULFENTRAZONE 20% W/W OIL DISPERSION

Sulfentrazone, one part of butyl benzoate, anionic surfactant, non-ionic surfactant and gel part comprising bentonite and remaining part of butyl benzoate were mixed in above quantity and processed as per the Example-1 to obtain oil dispersion composition.

TABLE 5
14 days Aging Data of Pourability

| | Example 9 | | Example 10 | |
|---|---|---|---|---|
| Pourability | AMBIENT | 14 D AHS | AMBIENT | 14 D AHS |
| Parameters | | | | |
| 0 inversion | 100 | 100 | 100 | 98.8 |
| 10 inversion | 99.95 | 99.9 | 100 | 99.85 |
| RVT, 60 | 183 | 153 | 406 | 184 |
| RPM, #3 | | | | |
| Spindle | | | | |
| (cPs) | | | | |

| | | |
|---|---|---|
| Remarks | Free flowing | Viscous free |
| | liquid | flowing liquid |

### EXAMPLE 11: FLUCARBAZONE 20% W/W+PYROXSULAM 6% W/W OD

| Ingredients | Quantity (% w/w) |
|---|---|
| Flucarbazone-sodium | 20.82 |
| Cloquintocet-mexyl | 4.87 |
| Pyroxsulam | 6.06 |
| Butyl benzoate | 39.05 |
| Anionic surfactants | 3 |
| Non-ionic surfactants | 12.5 |
| Ethoxylated phosphate ester | 1 |

Gel part

| | |
|---|---|
| Bentonite | 1 |
| Butyl benzoate | 11.7 |
| Total | 100 |

Flucarbazone-sodium, cloquintocet-mexyl, pyroxsulam, one part of butyl benzoate, anionic surfactant, non-ionic surfactant, ethoxylated phosphate ester and gel part comprising bentonite and remaining part of butyl benzoate were mixed in above quantity and processed as per the Example-1 to obtain oil dispersion composition.

TABLE 6
1 Week viscosity data

| | | |
|---|---|---|
| Parameters | Initial | 1 Week |

| Test | RT | 0° C. | −10° C. |
|---|---|---|---|
| Appearance | Free Flowing | Not frozen, | Not frozen, |
| | Liquid | Free flowing | Free flowing |
| Appearance on | N/A | Free Flowing | Free Flowing |
| thaw | | Liquid | Liquid |
| Viscosity, RVT, | 220 | 222 | 222 |
| 60 RPM, #3 | | | |
| Spindle (cPs) | | | |

The composition of Example-11 was evaluated for viscosity and visual observations. It appeared as free flowing liquid when tested at 0 day in ambient condition. The composition was kept in storage for cold temperature stability for 1 week at 0° C. and −10° C. It remained free flowing at both 0° C. and −10° C. Similarly, its viscosity remained almost constant at 0 day (ambient) as well as after 1 week when kept for cold temperature stability.

Inventors of the present invention thus successfully prepared an agrochemical oil dispersion by a process described in the present invention that involves preparation of colloid mixture of viscosity range 3500-5000 cps. The incorporation of colloid mixture comprising rheological additive and oil phase and its stage of addition during the process of preparing an agrochemical oil dispersion played critical role in obtaining stable composition. The compositions developed according to the process described in the present invention based by incorporating colloid mixture of 3500-5000 cps viscosity found to remain stable with desired pourability and viscosity.

1. A process for the preparation of a stable agrochemical oil dispersion comprising at least one active ingredient dispersed in an oil phase; and a colloid mixture of having a viscosity of 3500-5000 cps, wherein said process comprises:
(1) preparing a dispersion by mixing at least one active ingredient in the oil phase;
(2) separately, preparing a colloid mixture having the viscosity of 3500-5000 cps by mixing a rheological additive in an oil phase;
(3) adding the colloid mixture of step (2) in the dispersion of step (1) to obtain an agrochemical oil dispersion.

2. The process according to claim 1, wherein said active ingredient is selected from the group consisting of triazinone, triazole, triazolecarboxamide, triazolone, triazolinone and N-phenyltriazolinone herbicides.

3. The process according to claim 1, wherein said active ingredient is selected from the group consisting of hexazinone, metamitron, metribuzin, amicarbazone, flucarbazone, thiencarbazone, carfentrazone, sulfentrazone and their derivatives.

4. The process as claimed in claim 1, wherein said rheological additive is selected from the group consisting of clay, fumed silica, precipitated silica, bentonite and combinations thereof.

5. The process as claimed in claim 1, wherein said oil dispersion comprises of 5% w/w to 15% w/w of the colloid mixture of the total weight of the oil dispersion.

6. The process as claimed in claim 1, wherein said process comprises:
(1) preparing the dispersion by mixing at least one active ingredient in the oil phase, wherein the at least one active ingredient is triazolinone herbicide;
(2) milling the dispersion of step (1) to achieve a desired particle size;
(3) separately, preparing the colloid mixture having the viscosity of 3500-5000 cps by mixing the rheological additive in the oil phase to form the colloid mixture;
(4) adding the colloid mixture of step (3) to the dispersion of step (1) to obtain the agrochemical oil dispersion.

7. The process as claimed in claim 6, wherein said triazolinone herbicide is flucarbazone-sodium.

8. The process as claimed in claim 1, wherein a particle size of said active ingredient in the dispersion is from about 3 micron to about 12 micron.

9. The process as claimed in claim 1, wherein said colloid mixture is obtained by mixing said rheological additive and said oil phase and storing for 5 to-7 hours.

10. A stable agrochemical oil dispersion comprising:
at least one active ingredient dispersed in oil phase; and
a colloid mixture having a viscosity of 3500-5000 cps.

11. The stable agrochemical oil dispersion according to claim 10, wherein said active ingredient is flucarbazone-sodium.

12. The stable agrochemical oil dispersion according to claim 10, wherein said colloid mixture comprises of a rheological additive selected from the group consisting of clay, fumed silica, precipitated silica, bentonite and a combination thereof; and an oil phase.

13. The stable agrochemical oil dispersion according to claim 10, wherein a ratio of the rheological additive and the oil phase is from 1:5 to 1:15.

14. The stable agrochemical oil dispersion according to claim 10, wherein a viscosity of said oil dispersion is from 100-800 cps.

15. The stable agrochemical oil dispersion according to claim 10, wherein said oil dispersion comprises from about 1% w/w to about 70% w/w of the active ingredient and from about 5% w/w to about 15% w/w of the colloid mixture having the viscosity of 3500-5000 cps based on a total weight of the stable agrochemical oil dispersion.

16. The stable agrochemical oil dispersion according to claim 10, wherein said oil dispersion comprises from about 1% w/w to about 70% w/w of the active ingredient, from about 5% w/w to about 15% w/w of the colloid mixture based on a total weight of the stable agrochemical oil dispersion, wherein said colloid mixture comprises from about 0.1% w/w to about 10% w/w of a rheological aid and from about 1% w/w to about 50% w/w of an oil phase.

17. The stable agrochemical oil dispersion according to claim 10, wherein the active ingredient is from about 1% w/w to about 70% w/w flucarbazone sodium, and the colloid mixture is from 5% w/w to about 15% w/w based on a total weight of the stable agrochemical oil dispersion, wherein said colloid mixture comprises from about 0.1% w/w to about 10% w/w bentonite and from about 1% w/w to about 50% w/w butyl benzoate based on a total weight of the colloid mixture.

18. The stable agrochemical oil dispersion according to claim 10, further comprising a second herbicide selected from the group consisting of aryloxyphenoxypropionic, anilide, acetamide, chloroacetamide, cyclohexanedione, diphenylether, triazolopyrimidine, triketone, triazinylsulfonylurea, phenylpyrazoline, and pyridinecarboxylic acid group of herbicides.

19. The stable agrochemical oil dispersion according to claim 18, wherein the second active ingredient is selected from the group comprising of clodinafop, haloxyfop, cyhalofop, napropamide, propanil, acetochlor, butachlor, metolachlor, s-metolachlor, clethodim, sethoxydim, fomesafen, oxyfluorfen, florasulam, penoxsum, pyroxsulam mesotrione, tembotrione, tribenuron, thiefensulfuron, metulfuron, pinoxaden, halauxifen, their derivatives, and combinations thereof.

20. The stable agrochemical oil dispersion according to claim 10, wherein said oil dispersion comprises the active ingredients from about 1% w/w to about 70% w/w flucarbazone sodium, and from about 1% w/w to about 70% w/w fenoxaprop-P-ethyl, and the colloid mixture from 5% w/w to about 15% w/w based on a total weight of the stable agrochemical oil dispersion, wherein said colloid mixture comprises from about 0.1% w/w to about 10% w/w bentonite and from about 1% w/w to about 50% w/w butyl benzoate based on a total weight of the colloid mixture.

21. The stable agrochemical oil dispersion according to claim 10, wherein said oil dispersion comprises the active ingredients from about 1% w/w to about 70% w/w flucarbazone sodium, and from about 1% w/w to about 70% w/w pyroxsulam, and hrte colloid mixture from 5% w/w to about 15% w/w based on a total weight of the stable agrochemical oil dispersion, wherein said colloid mixture comprises from about 0.1% w/w to about 10% w/w bentonite and from about 1% w/w to about 50% w/w butyl benzoate based on a total weight of the colloid mixture.

22. A method of controlling weeds, wherein said method comprises applying onto weeds or to their locus, an agrochemical oil dispersion comprising: at least one active ingredient dispersed in an oil phase; and a colloid mixture having a viscosity of 3500-5000 cps.

23. The method according to claim 22, wherein the at least one active ingredient comprises flucarbazone-sodium.
